(19) United States
(12) Patent Application Publication
(10) Pub. No.: US 2012/0174784 A1
(43) Pub. Date: Jul. 12, 2012

(54) METHOD AND APPARATUS FOR CO2 CAPTURE

(75) Inventors: Knut Ingvar Asen, Porsgrunn (NO); Torbjorn Fiveland, Skien (NO); Dag Arne Eimer, Porsgrunn (NO); Nils Henrik Eldrup, Stathelle (NO)

(73) Assignee: STATOIL PETROLEUM AS, Stavanger (NO)

(21) Appl. No.: 13/383,007

(22) PCT Filed: Jul. 9, 2010
(86) PCT No.: PCT/NO2010/000279

§ 371 Date: Mar. 23, 2012

(30) Foreign Application Priority Data
Jul. 10, 2009 (NO) 20092627

(51) Int. Cl. B01D 53/14; B01D 53/18

(52) U.S. Cl. 95/199; 261/116

(57) ABSTRACT

Disclosed is a method for capturing C02 from a gas stream (10) by introducing droplets of an absorption liquid (15, 17, 40) into the gas stream mainly in the flow direction of the gas. According to the invention, CO2 is captured from the gas stream during a capture phase by means of the absorption liquid droplets, where the absorption liquid droplets are airborne during the capture phase, absorption liquid droplets are introduced into the gas stream with a velocity high enough to ensure internal circulation inside the absorption liquid droplets, and the absorption liquid droplets are introduced into the gas stream with a Sauter mean diameter in the range of 50 10E-6 m-500 10E-6·m. An apparatus suitable for conducting said method is also disclosed.

The present invention relates to an apparatus for capturing CO₂ from an exhaust gas stream and a method therefore.

In the combustion of a fuel, such as coal, oil, gas, peat, waste, etc., in a combustion plant, such as those associated with boiler systems for providing steam to a power plant, a hot process gas (or flue gas) is generated. Such a flue gas will often contain, among other things, carbon dioxide (CO₂). The negative environmental effects of releasing carbon dioxide to the atmosphere have been widely recognised, and have resulted in the development of processes adapted for removing carbon dioxide from the hot process gas generated in the combustion of the above mentioned fuels.

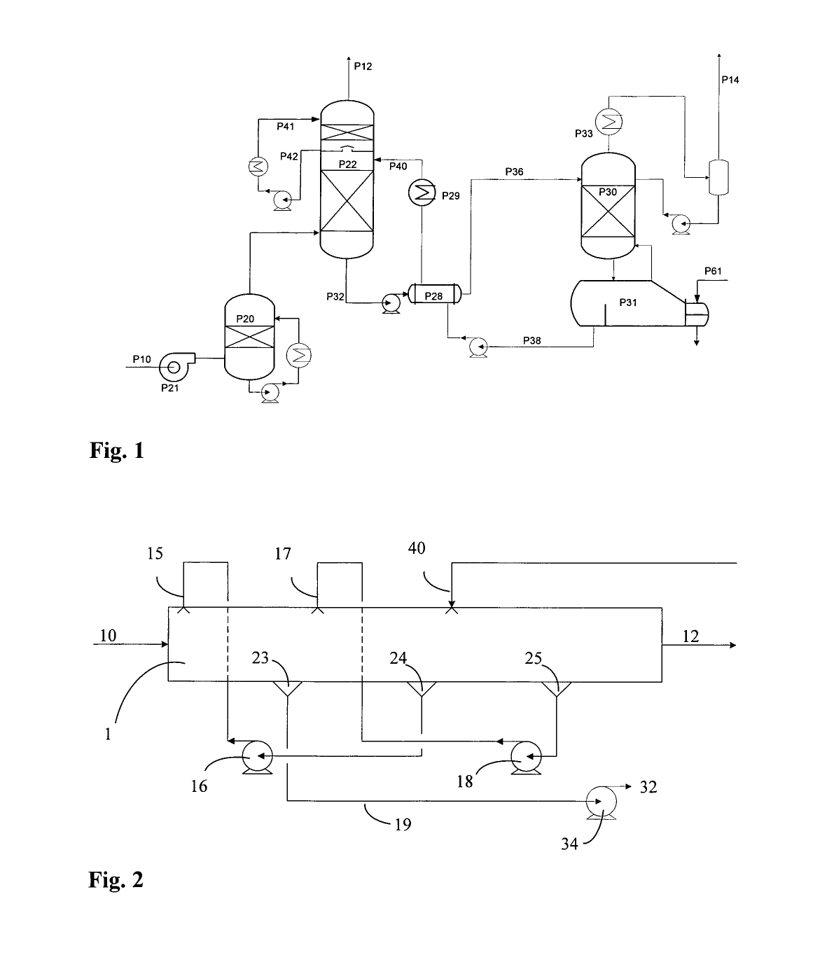

The conventional method for removing CO₂ from exhaust gas would be by use of a standard absorption-desorption process illustrated in FIG. 1. In this process the exhaust gas has its pressure boosted by a blower either before or after an indirect or direct contact cooler. Then the exhaust gas is fed to an absorption tower where it is counter-currently brought into contact with an absorbent flowing downwards. In the top of the column a wash section is fitted to remove, essentially with water, remnants of absorbent following the exhaust gas from the CO₂ removal section. The absorbent rich in CO₂ from the absorber bottom is pumped to the top of the desorption column via a heat recovery heat exchanger rendering the rich absorbent pre-heated before entering the desorption tower. In the desorption tower the CO₂ is stripped by steam moving up the tower. Water and absorbent following CO₂ over the top is recovered in the condenser over the desorber top. Vapour is formed in the reboiler from where the absorbent lean in CO₂ is pumped via the heat recovery heat exchanger and a cooler to the top of the absorption column.

The known processes for removing CO₂ from exhaust gas involve equipment that causes a pressure drop in the exhaust gas. If such a pressure drop is allowed, it would cause a pressure build-up in the outlet of the power generating plant or other plant generating the exhaust gas. This is undesirable. In the case of a gas turbine it would lead to reduced efficiency in the power generating process. To counter this drawback a costly exhaust gas blower is needed.

A further problem with existing technology is that the absorption tower and the preceding exhaust gas cooler are costly items.

The standard CO₂ capture plant also needs a significant area to build upon. WO00/74816 discloses a system for CO₂ capture. The system may be arranged as a horizontal channel where the exhaust gas is brought in contact with two different absorption liquids in two adjacent sections. A screen is included to avoid liquid to be transported from one section into the next section. The liquids are being regenerated and recalculated.

In the article “Critical flow atomizer in SO₂ spray scrubbing” by Bandyopadhyay et al (Chemical Engineering Journal 139, pp. 29-41, 2008), it is concluded SO₂ removal efficiency is increased with the increase in liquid flow rate, liquid-to-gas flow rate ratio, atomizing air pressure, droplet velocity. The same conclusion is reached by Srinivasan et al in the article “Mass transfer to droplets formed by the controlled breakup of a cylindrical jet—physical absorption” (Chemical Engineering Science, Vol. 43, No. 12, pp. 3141-3150, 1988)

The aim of the present invention is to provide a method and apparatus for removing CO₂ from an exhaust gas stream, where the method provides a reduced pressure loss, does not depend on the use of exhaust gas blowers and preferably requires less energy than the traditional method. Furthermore, it is an aim to provide a solution which has a considerably smaller footprint. It is also a goal to provide a solution which can be integrated with a new efficient desorption method and apparatus.

A further goal is to provide a system and a method that can be effectively combined to a plant utilizing recycling of exhaust gas.

It is also intended to provide a system which allows for combination with pre-treatment systems for removing other unwanted compounds within the gas stream.

The abovementioned aims and goals are reached by means of a system and method according to the enclosed independent claims. Further advantageous features and embodiments are mentioned in the dependent claims.

The present invention relates to CO₂ capture from exhaust gas, and it is a so called post combustion technology. The present invention may be utilized in connection with gases coming from different kind of facilities. These facilities could be combined cycle gas fired power plants; coal fired power plants, boilers, cement factories, refineries, heating furnaces of endothermic processes such as steam reforming of natural gas or similar sources of flue gas containing CO₂.

A long exhaust channel will be needed in almost all cases of CO₂ capture from exhaust gas for transporting the gas from the plant generating the gas to the plant for capturing CO₂. Putting it to good use does not involve extra cost for the exhaust channel as such.

According to one aspect of the present invention, the necessary contact area between gas and liquid is provided by spraying liquid droplets into the gas in the exhaust gas channel itself thus eliminating the absorption tower. The direct contact cooler normally preceding this tower may also be replaced by doing the same contacting in a section in the channel itself.

It is an aim of the present invention to exploit a part of an exhaust gas channel that is needed anyway to transport the exhaust gas to the CO₂ capture plant. It is not normally space to build the CO₂ capture plant back-to-back with the power plant. In so doing, the conventional DCC and absorption column are eliminated. This exploitation represents a very significant cost saving.

The channel is expected to be essentially horizontal, but it could have an angle between 0° and 60°. The direction of the slope can go either way, and the direction of the slope may change along the path of the channel. The channel may also change direction one or several times, from 1 to 360 degrees.

The present invention reduces both capital cost and saves energy.

According to one embodiment of the present invention, nozzles direct the spray mainly in the flow direction of the exhaust gas thus pushing the gas along in the channel. The kinetic energy from the droplets thus imparted on the gas more than overcomes the gas pressure drop in the channel. This means that the upstream channel(s) can be operated at to a lower absolute pressure. A consequence of this is that the exit pressure from the upstream gas turbine (when applicable) may operate at a reduced pressure compared to the standard technology, and this reduced pressure at gas turbine exit increases the gas turbine efficiency leading to a higher power production.

It reduces the capital cost, saves energy, and may even lead to increased energy production from the gas turbine.

These and other objectives are reached by the method according to claim 1 and an apparatus according to claim 6. Other benefits and advantageous embodiments are set out in the dependent claims.

The present invention will be described in more detail with reference to the enclosed figures; wherein:

FIG. 1 illustrates a conventional absorption-desorption process;

FIG. 2 illustrates a flow sheet of an embodiment of the present invention;

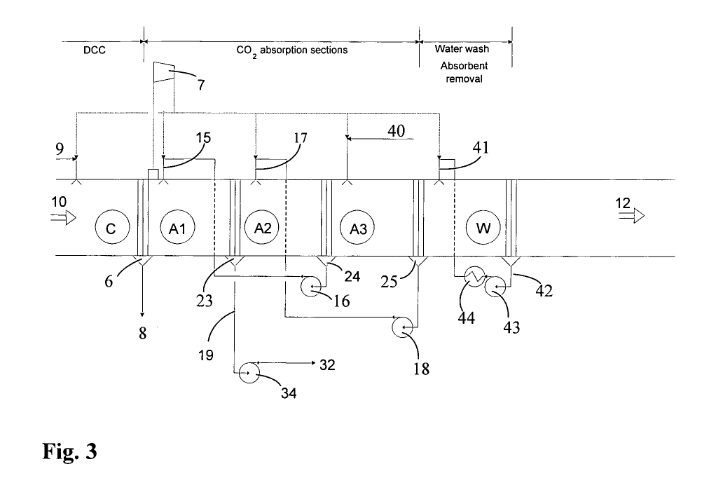

FIG. 3 illustrates an embodiment where the channel includes direct contact cooling and a washing section;

FIG. 4 shows the operating and equilibrium lines for the CO₂ absorption process shown in FIG. 3;

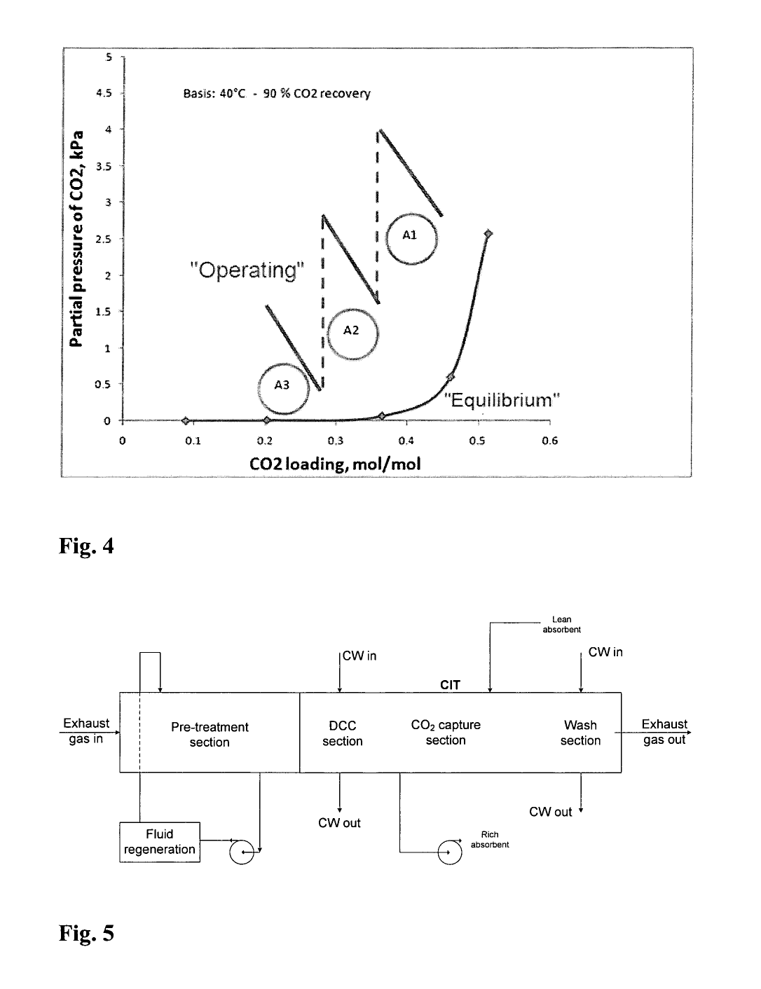

FIG. 5 illustrates an embodiment with an integrated pre-treatment section;

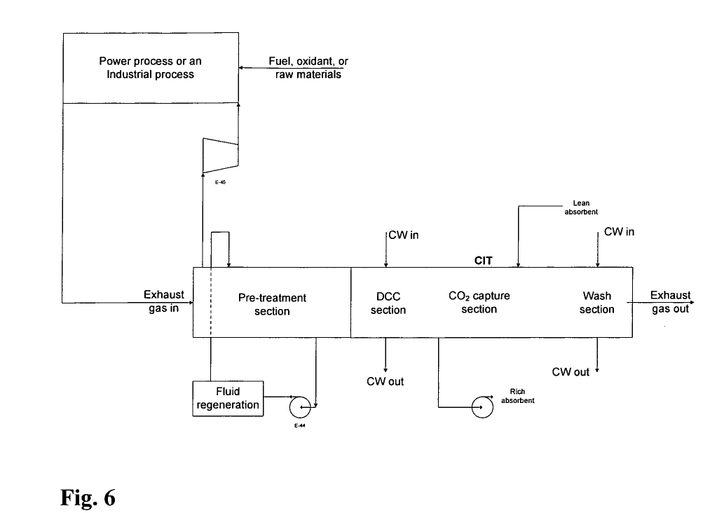

FIG. 6 illustrates the embodiment with exhaust gas recycling; and

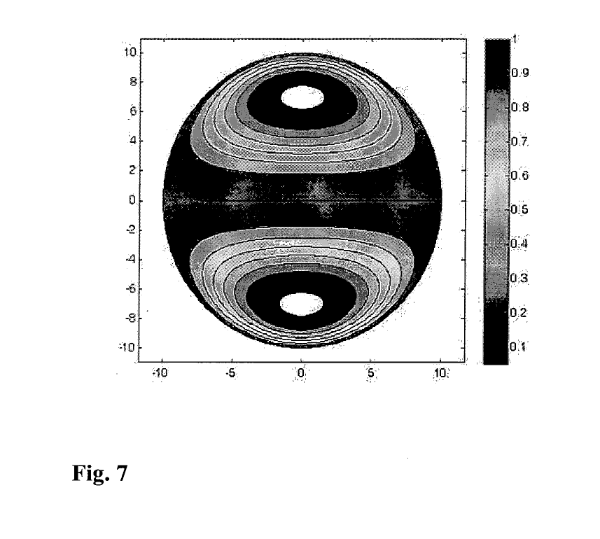

FIG. 7 shows a cross-section showing the relative velocity of the internal circulation pattern developed in a liquid drop moving in gas.

FIG. 1 shows a conventional method for removing CO₂ from exhaust gas using a standard absorption-desorption process. In this process the exhaust gas P10 has its pressure boosted by a blower P21 either before (as illustrated) or after an indirect or direct contact cooler P20. Then the exhaust gas is fed to an absorption tower P22 where it is contacted counter-currently with an absorbent P40 flowing downwards. In the top of the column a wash section is fitted to remove, essentially with water, remnants of absorbent following the exhaust gas from the CO₂ removal section. Washing liquid P41 is entered at the top and redrawn further down as P42. The CO₂ depleted exhaust gas is removed over the top as P12. The absorbent rich in CO₂ P32 from the absorber bottom is pumped to the top of the desorption column P30 via a heat recovery heat exchanger P28 rendering the rich absorbent P36 pre-heated before entering the desorption tower is P30. In the desorption tower the CO₂ is stripped by steam moving up the tower. Water and absorbent following CO₂ over the top is recovered in the condenser P33 over the desorber top. Vapour is formed in the reboiler P31 from where the absorbent lean in CO₂ P38 is pumped via the heat recovery heat exchanger P28 and a cooler P29 to the top of the absorption column P22. Steam is supplied to the reboiler as stream P61. The isolated CO₂ leaves as stream P14.

FIG. 2 illustrates the main fluid flows of an embodiment of the present invention. Exhaust gas 10 enters the channel 1 at one end. Absorption liquid comprising a CO₂ absorbent and a diluent is sprayed into the channel from a nozzle arrangement 15. The absorption liquid is sprayed mainly in the flow direction of the exhaust gas and with a speed high enough to at least compensate for the pressure loss in the first part of the channel. The droplets of absorption liquid moves trough the exhaust gas stream and absorbs CO₂ there from. The CO₂ rich absorption liquid is collected upstream at collection point 23 at the lower part of the channel. The droplets are collected by the use of an demister/droplet catcher. The CO₂ rich absorption liquid 19 is pumped via pump 34 into conduit 32 connected to a desorption plant. The desorption plant may be a traditional desorption plant as illustrated in FIG. 1 or it can be any other system for desorbing CO₂ from an absorbent liquid. In the embodiment illustrated on FIG. 2 the exhaust gas continues downstream in the channel and a second absorption liquid is sprayed into the gas from a nozzle arrangement 17. The absorption liquid is sprayed mainly in the flow direction of the exhaust gas and with a speed high enough to at least compensate for the pressure loss in this second part of the channel. The droplets of absorption liquid move trough the gas stream and absorbs CO₂ there from. The CO₂ rich absorption liquid is collected upstream at collection point 24 at the bottom of the channel. The CO₂ rich absorption liquid collected at point 24 is pumped via pump 16 up to the nozzle arrangement 15. The exhaust gas continues downstream in the channel and lean absorption liquid 40 is sprayed into the gas from a nozzle arrangement. The absorption liquid is sprayed mainly in the flow direction of the exhaust gas and with a speed high enough to at least compensate for the pressure loss in this third part of the channel. The droplets of absorption liquid move trough the exhaust gas stream and absorb CO₂ there from. The CO₂ rich absorption liquid is collected upstream at collection point 25 at the lower part of the channel. The CO₂ rich absorption liquid collected at point 25 is pumped via pump 18 up to the nozzle arrangement 17. The CO₂ depleted exhaust gas leaves the channel at the other end as stream 12.

The channel may be horizontal or have an angle of up to 60 degrees. The channel may further include one or more demisters or similar arrangement to collect the droplets of absorption liquid. The droplets will then be introduced at a speed large enough to push the gas stream forward through the demisters.

FIG. 2 illustrates the basic configuration of cross-flow treatment in the exhaust gas channel. The nozzles in this figure are pointing downwards. This is, however, only for convenience of drawing. The intention is to point the nozzles mainly in the direction of the gas flow, but other configurations may also be feasible, e.g. an array or cluster of nozzles pointing in various directions. More examples could be given.

One embodiment of the present invention may be described with reference to FIG. 3. The exhaust gas enters the exhaust gas channel that would normally be void of process equipment for the 150-250 meters leading to the conventional CO₂ capture plant. At a convenient point shortly after entry the exhaust gas is here, in section C, sprayed with cooling water to form a direct contact cooler. The cooling water is recycled except a possible purge. The recycle is via pump and cooler to a point where this stream is mixed with compressed gas in the spray nozzles (atomizing nozzles). Droplets created in this section are collected in the downstream droplet catchers.

In another embodiment, the pressure of the cooling water is increased to 5-100 bars, preferably in the range 5-10 bar, with a pump before it exits through spray nozzles. The absorbent liquid may also be introduced to the channel in the same way.

The gas for nozzle spraying is compressed in a compressor common for all nozzle batteries that uses atomizing nozzles. In one embodiment, the suction gas is exhaust gas conveniently extracted from the channel downstream of the DCC section droplet catchers.

The cooled exhaust gas now enters CO₂ absorption section A1 where is contacted concurrently and cross-currently with the CO₂ richest absorbent solution passing through the absorption process. The liquid is again sprayed into the channel via nozzles. The liquid droplets are captured in the downstream droplet catchers. The rich absorbent liquid collected is pumped from the A1 section to the desorption process not further described here. The liquid absorbent sprayed into section A1 is pumped from section A2 where there is less CO₂ in the exhaust gas and the outlet liquid is thus less rich in CO₂ than that coming out of the A1 section. The operating and equilibrium lines for the CO₂ removal process are shown in FIG. 4. Also the A2 section has gas liquid contact following the same pattern as in section A1. The liquid to section A2 comes from section A3 where the CO₂ levels are the lowest in both the exhaust gas and the liquid. The absorbent liquid sprayed into section A3 is the lean absorbent coming back from the desorption process in a regenerated condition. The droplet catchers downstream of section A3 would favourably be designed to do a more rigid droplet capture than the other sections since any slippage of absorbent will put a higher demand on the absorbent recovery section W.

The function of section W is to wash essentially all absorbent carried with the gas from section A3 out. This is achieved by circulating essentially water over the section via a pump and a cooler. A bleed to recycle caught absorbent and a make-up water stream would be applied as convenient to the recycle stream. The potential for removing absorbent from the exhaust gas is determined by the concentration of free absorbent in the wash liquid, and its temperature. There may a need for more than one such wash section, and that may be easily added.

It has been found that the droplet sprays are pushing the gas along the channel to the extent that no exhaust gas blower is needed.

The number of stages needed for CO₂ absorption is a trade-off against absorbent flow. In principle one stage would be enough if sufficient liquid was circulated, but this would imply a lot of liquid. Two stages or more are conceivable. In the standard counter-current absorption column it may be shown that 2 to 3 equilibrium stages would suffice.

According to one embodiment, the present invention may be combined with a pre-treatment section and a recycling of exhaust gas. These features are described in more detail in FIGS. 5 and 6.

In FIG. 5, one embodiment of the present invention is shown extended with exhaust gas pre-treatment. This is relevant for coal fired power stations and a variety of industrial settings where CO₂ recovery is needed. The pre-treatment could have one or more duties. It could e.g. be a sea water wash where the buffering propertied of sea water is exploited to absorb SO₂ from the exhaust gas. If this was not done, SO₂ would react irreversibly with the alkaline absorbent used to catch CO₂ thus leading to a greater consumption. Such a process could also scrub the exhaust gas for particles. Both these functions would typically be required downstream of coal burning. From an aluminium melter the exhaust gas might contain HF, and more examples could be given. The fluid regeneration in the pre-treatment section could e.g. be a filter to contain particles. In the case of SO₂ absorption into sea water the best course of action is to have a bleed where SO₂ is piped with sea water as sulphite that would in turn be oxidised to sulphate in the sea water, a substance that is already in sea water in abundance.

The pre-treatment section could use the same technologies for nozzles and droplet catchers as the other sections.

In FIG. 6, one embodiment of the present invention is shown integrated with a pre-treatment section and combined with an exhaust gas recycle (EGR). The advantage of using an EGR is that the volumetric exhaust gas flow is significantly reduced thus enabling a reduction in the cross-sectional area in the gas flow sections and the higher CO₂ content in the exhaust gas which reduces the capital cost of treatment.

FIG. 7 is a cross-section showing the relative velocity of the internal circulation pattern developed in a liquid drop moving in gas. The gas motion is in the horizontal direction and results in a doughnut shaped, toroid flow known as a Hill's vortex. The cause of the internal circulation is the shear force at the surface of the liquid drop, created by the gas moving along the surface. It is known that a liquid drop moving through a viscous fluid, e.g. gas stream comprising CO₂, will tend to circulate internally due to the shear stress applied at its interface by the ambient fluid. Heat and mass transfer are greatly augmented by a reduction of the boundary layer thickness. Compared to a so-called rigid drop (i.e. a liquid drop with no, or very little, internal circulation), the transfer coefficients for a liquid drop with internal circulation is at least 2-4 times higher.

According to an advantageous embodiment of the present invention, an absorption liquid, e.g. amine, is introduced or sprayed into a channel 1 by the use of atomizing nozzles 15, 17, 40. A flue gas 10 comprising a gas stream comprising CO₂ moves through the channel 1 with a velocity of 5-15 m/s. The diameter of the flue gas channel 1 may depend on the amount of flue gas produced by the power plant, cement factory or similar, but it will in most cases be between 3 and 10 meters. The flow conditions in the flue gas channel will thus be highly turbulent with a Reynolds number>>100 000.

The absorption liquid leaves the nozzle or nozzles 15, 17, 40 as small droplets with a velocity of 30-120 m/s. It is expected that the droplets will be turbulent for a short while after they leave the nozzle, 1-2 seconds. The relative velocity difference between the absorption liquid droplets and the flue gas causes high shear stress on the droplets which will help sustain an internal circulation inside the droplets and possibly sustain turbulent conditions inside the droplets. The mass transfer in the region adjacent to the nozzles will thus be extremely high.

A major drawback of packed bed absorber is the ability to mass transfer of CO₂(g) to CO₂(aq). The mass transfer rate depends on the gas film thickness and a corresponding diffusion. These again depend on flow rates. In packed bed absorbers, laminar flow will occur, which results in significantly lower mass transfer of CO₂(g) to CO₂(aq) compared to turbulent flow conditions. The high turbulence in the channel 1 and the turbulence/internal circulation in the droplets results in significantly reduced resistance to mass transfer. As opposed to conventional methods for absorbing CO₂ from a flue gas 10, the transport of CO₂ from the flue gas 10 into the absorption liquid droplets will be much higher due to reduced film thickness and the transport of CO₂(aq) is not dependent on diffusion, but by convection. The reaction with absorbent will thus be a lot faster.

Absorption liquid droplet size can be varied by changing pressure on the absorption liquid before the nozzle or nozzles, or by the absorption liquid flow rate through the nozzle or nozzles. The size and shape of the nozzle or nozzles will also have an effect on the absorption liquid droplet size. The relative difference in velocity between the mean gas stream and the mean absorption liquid droplet velocity will also affect the droplet size. If the velocity ratio between the mean gas stream velocity and the mean absorption liquid droplet velocity is greater than approximately 3 when the absorption liquid leaves the absorption liquid introduction means, preferably in the range of 6-10, this will help ensure internal circulation in the absorption liquid droplets introduced in the CO₂ gas stream, and that the Sauter mean diameter of the absorption liquid droplets is kept relatively small, preferably on the order of 50 μm-500 μm.

The residence or flight time of the absorption liquid droplets through the channel 1 is also important. As the absorption liquid droplets moves through the flue gas channel, the initial collision between the droplets and the flue gas will contribute towards further atomization of the droplets. Simultaneously, the shear forces/stress on the droplets will help sustain an internal circulation inside the droplets. In this initial phase of the absorption liquid droplet flight, the mass transfer of CO₂ from the flue gas and into the absorption liquid droplets reach a peak. As the absorption liquid droplets move along the channel 1, their velocity decreases due to multiple collisions and drag forces (the kinetic energy is transferred from droplet to the flue gas). Furthermore, the absorption liquid droplets may also increase in size due to coalescence, further decreasing their velocity and a reduction of the active liquid surface area. The absorption liquid droplets also start to saturate due to reaction with CO₂(aq). In effect, the mass transfer of CO₂ from the flue gas and into the absorption liquid droplets starts to decrease. This period between the introduction of the absorption liquid droplets into the channel 1 and a very diminished mass transfer of CO₂ from the flue gas, defines the desired residence or flight time of the absorption liquid droplets in the gas stream, and thereby also helps determine a preferable length of the channel 1 before the absorption liquid is collected, e.g. by droplet catchers. In light of this, it can be understood that any obstacles in the channel, e.g. packing material of a packed bed absorber etc., will only shorten the residence or flight time, and thus be of detriment for the mass transfer of CO₂ from the flue gas and into the absorption liquid droplets. Also, any obstacles in the channel, e.g. packing material etc., may increase pressure loss along the channel, which preferably should be avoided.

According to the present invention, the absorption of CO₂ takes place while the absorption liquid droplets are airborne, i.e. suspended in the gas stream containing CO₂. This is also referred to as the capture phase. The capture phase takes place in the capture zone. The capture zone can be defined as the area or volume between the absorption liquid introduction means and a collection point of the absorption liquid downstream of the absorption liquid introduction means. According to the present invention, it is preferred that no obstacles, e.g. packing materials or other surfaces, which may result in that absorption liquid collects in or on the obstacles, are present in this capture zone or during the capture phase. The main benefit of the present invention is obtained by providing a transfer of CO₂ from the gas stream and into the absorption liquid while the absorption liquid is airborne or suspended in the gas stream. However, it is conceivable that a further CO₂ capturing stage comprising a packed bed absorber or some other capture means is provided after the capture zone according to the present invention. For example, collection means 23 for collecting CO₂ saturated absorption liquid droplets downstream of the absorption liquid introduction means 15, 17, 40 may in part comprise a packed bed absorber or some other capture means.

According to one embodiment of the present invention, the temperature of the absorption liquid introduced into the gas stream is in the range of 20° to 80° C., preferably in the range of 20° to 50° C. However, this depends on the kind of absorption liquid used, and it is conceivable that other absorption liquids with other temperature ranges may be utilized.

It is understood that the benefits of the present invention can be obtained even when varying the various parameters of the process. Parameters that have an effect on the mass transfer of CO₂ from the flue gas and into the absorption liquid droplets are:
channel diameter
channel shape
channel length
residence or flight time of absorption liquid droplets
channel surface
number of nozzles
placement of nozzles
shape and design of nozzles
pressure of absorption liquid droplets before exiting nozzles
flow rate of absorption liquid droplets through nozzles
velocity of flue gas
velocity of absorption liquid droplets
velocity ratio between the flue gas and the absorption liquid droplets
temperature of absorption liquid droplets
temperature of flue gas
concentration of CO₂ in flue gas
flow rate of flue gas
concentration of absorption liquid
viscosity of absorption liquid
   etc.

The person skilled in the art, upon reading this, will be able to achieve the benefits of the present invention set out in the claims below, as long as the parameters listed above are tuned such that:
CO₂ is captured from the gas stream during a capture phase by means of the absorption liquid droplets, where the absorption liquid droplets are airborne during the capture phase;
absorption liquid droplets are introduced into the gas stream with a velocity high enough to ensure internal circulation inside the absorption liquid droplets, and
the absorption liquid droplets are introduced into the gas stream with a Sauter mean diameter in the range of 50 μm-500 μm.

1. Method for capturing CO₂ from a gas stream comprising the steps of
introducing droplets of an absorption liquid into the gas stream mainly in the flow direction of the gas;
capturing CO₂ from the gas stream during a capture phase by means of the absorption liquid droplets, where the absorption liquid droplets are airborne during the capture phase;
introducing the absorption liquid droplets into the gas stream with a velocity high enough to ensure internal circulation inside the absorption liquid droplets; and
providing that the Sauter mean diameter of the absorption liquid droplets introduced into the gas stream is in the range of 50 μm-500 μm.

2. Method according to claim 1, wherein the velocity ratio between the mean gas stream velocity and the mean absorption liquid droplet velocity is greater than 3 when the absorption liquid leaves the absorption liquid introduction means.

3. Method according to claim 1, wherein the temperature of the absorption liquid introduced into the gas stream is in the range of 20° to 80° C.

4. Method according to claim 1, wherein the gas stream comprising CO₂ has a velocity of 5-15 m/s and the absorption liquid droplets have a velocity of 30-120 m/s, where the gas stream velocity and absorption liquid droplet velocity are mainly parallel.

5. Method according to claim 1, wherein CO₂ rich absorption liquid droplets are collected downstream of the absorption liquid introduction means.

6. Method according to claim 1, wherein the absorption liquid droplets are introduced with a velocity high enough to force the gas stream through the CO₂ capturing phase without the use of additional equipment for compressing the gas stream.

7. Method according to claim 5, wherein there are no internals between the absorption liquid introduction means and the collection of the CO₂ saturated absorption liquid droplets.

8. Method according to claim 1, wherein the CO₂ gas stream is highly turbulent.

9. Apparatus for capturing CO₂ from a gas stream comprising:
absorption liquid introduction means for introducing droplets of an absorption liquid mainly in the flow direction of the CO₂ gas stream
wherein the apparatus comprises a capture zone wherein the absorption liquid droplets capture CO₂ from the gas stream, where the absorption liquid droplets are airborne throughout the capture zone,
is adapted to introduce the absorption liquid droplets with a velocity high enough to ensure internal circulation inside the absorption liquid droplets, and
is adapted to provide absorption liquid droplets with a Sauter mean diameter in the range of 50 μm-500 μm.

10. Apparatus according to claim 9, wherein the lean absorption liquid droplets are introduced into the CO₂ gas stream with a velocity of 30-120 m/s;

11. Apparatus according to claim 9, wherein the CO₂ gas stream has a velocity of 5-15 m/s.

12. Apparatus according to claim 9, comprising collection means for collecting CO₂ saturated absorption liquid droplets downstream of the absorption liquid introduction means and capture zone.

13. Apparatus according to claim 9, wherein the absorption liquid introduction means are adapted to introduce absorption liquid droplets with a velocity high enough to force the gas stream through the apparatus without the use of additional equipment for compressing the gas stream.

14. Apparatus according to claim 12, further comprising no internals between the absorption liquid introduction means and the collection means of the CO₂ saturated absorption liquid droplets.

15. Apparatus according to claim 9, comprising a channel for conducting the CO₂ gas stream, where the channel is provided with the absorption liquid introduction means and the collection means for collecting absorption liquid droplets downstream of the absorption liquid introduction means, the channel defining the capture zone between the absorption liquid introduction means and the collection means for collecting absorption liquid droplets.

16. Apparatus according to claim 9, wherein the gas stream is highly turbulent.

17. Apparatus according to claim 9, where the velocity ratio between the mean CO₂ gas stream velocity and the mean absorption liquid droplet velocity is greater than 3 when the absorption liquid leaves the absorption liquid introduction means.

18. Apparatus according to claim 9, where the absorption liquid introduction means comprises a nozzle or nozzles.

19. Apparatus according to claim 9, where the collection means for collecting absorption liquid droplets comprises a droplet catcher and/or a demister.
